(19) United States
(12) Patent Application Publication
(10) Pub. No.: US 2024/0332516 A1
(43) Pub. Date: Oct. 3, 2024

(54) RECHARGEABLE BATTERY CELL

(71) Applicant: Innolith Technology AG, Basel (CH)

(72) Inventors: Laurent Zinck, Mothern (FR); Christian Pszolla, Bad Schönborn (DE); Rebecca Busch, Füllinsdorf (CH)

(21) Appl. No.: 18/743,951

(22) Filed: Jun. 14, 2024

Related U.S. Application Data
(63) Continuation of application No. PCT/EP2022/085941, filed on Dec. 14, 2022.

(30) Foreign Application Priority Data
Dec. 17, 2021 (EP) 21 215 533.7

(51) Int. Cl. H01M 4/38; H01M 4/02; H01M 4/583; H01M 10/0563

(52) U.S. Cl. CPC H01M 4/38; H01M 4/583; H01M 10/0563; H01M 2004/027

(57) ABSTRACT

A rechargeable battery cell has an active metal, at least one positive electrode, at least one negative electrode, a housing and an electrolyte. The active metal is sodium and the electrolyte is based on SO₂ and contains a first conductive salt which has the formula (I)

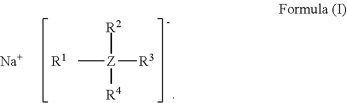

R¹, R² and R³ can be a halogen atom, a hydroxy group or a chemical group —OR⁵. R⁴ can be a hydroxy group or a chemical group —OR⁵. R⁵ can be C₁-C₁₀ alkyl, C₂-C₁₀ alkenyl, C₂-C₁₀ alkynyl, C₃-C₁₀ cycloalkyl, C₆-C₁₄ aryl or Cs-C₁₄ heteroaryl. The aliphatic, cyclic, aromatic and heteroaromatic groups can be unsubstituted or substituted. Z is aluminum or boron. At least two of the substituents R¹, R², R³ and R⁴ can jointly form a chelate ligand which is coordinated to Z.

### RELATED APPLICATIONS

This application is a continuation of PCT/EP2022/085941, filed Dec. 14, 2022, which claims priority to EP 21 215 533.7, filed Dec. 17, 2021, the entire disclosures of both of which are hereby incorporated herein by reference.

### BACKGROUND

This disclosure relates to a rechargeable battery cell comprising sodium as an active metal. Rechargeable battery cells are of great importance in many technical fields. They are often used for applications that only require small, rechargeable battery cells with relatively low current levels, such as when operating mobile phones. In addition, however, there is also a great need for larger, rechargeable battery cells for high-energy applications, with mass storage of energy in the form of battery cells for electrically driven vehicles being of particular importance.

An important requirement for such rechargeable battery cells is a high energy density. This means that the rechargeable battery cell should contain as much electrical energy as possible per unit of weight and volume. Lithium has proven to be particularly advantageous as the active metal for this purpose. However, one disadvantage of lithium cells is the limited availability of lithium in the world. Therefore, many research groups in this field are trying to find a replacement for lithium as an active metal that offers the significant advantages of lithium but is at the same time easily accessible and cost-effective. Sodium is being investigated as a possible lithium replacement.

The active metal of a rechargeable battery cell is the metal whose ions migrate within the electrolyte to the negative or positive electrode during charging or discharging of the cell and take part in electrochemical processes there. These electrochemical processes lead directly or indirectly to the release of electrons into the external circuit or to the electrons being taken up from the external circuit. As mentioned above, lithium or sodium can be active metals. Rechargeable battery cells that contain lithium or sodium as the active metal are also referred to as lithium-ion cells or sodium-ion cells. Lithium-ion cells have been known for a long time and are described in detail in the prior art. In contrast, sodium-ion cells have only been the focus of research since 2010 and are described in more detail below. Most research activities have been devoted to the discovery of high-performance anodes to increase the energy density of sodium-ion batteries, since graphite, the main material used in lithium-ion cells, has a much lower storage capacity for sodium compared to lithium.

Just as any rechargeable battery cell, the sodium-ion cell has a housing in which at least one positive electrode with a conducting element, at least one negative electrode with a conducting element and one electrolyte are arranged. Both the positive and the negative electrode of the sodium-ion cells known from prior art are designed as insertion electrodes. The term “insertion electrode” in the context of this disclosure is understood to refer to electrodes that have a crystal structure in which ions of the active metal can be intercalated and from which ions of the active metal can be deintercalated during the operation of the sodium-ion cell. This means that the electrode processes can take place not only on the surface of the electrodes, but also within the crystal structure.

The electrolyte is also an important functional element of every rechargeable battery cell. It usually contains a solvent or a mixture of solvents and at least one conductive salt. Solid electrolytes or ionic liquids, for example, do not contain any solvent, only a conductive salt. The electrolyte is in contact with the positive and negative electrodes of the battery cell. At least one ion of the conductive salt (anion or cation) is mobile in the electrolyte in such a way that ion conduction allows a charge transport to occur between the electrodes, which is necessary for the function of the rechargeable battery cell. Above a certain upper cell voltage of the rechargeable battery cell, the electrolyte is electrochemically decomposed by oxidation. This process often leads to the irreversible destruction of components of the electrolyte and thus to failure of the rechargeable battery cell. Reductive processes can also decompose the electrolyte below a certain lower cell voltage. In order to avoid these processes, the positive and negative electrodes are selected in such a way that the cell voltage is below or above the decomposition voltage of the electrolyte. The electrolyte thus determines the voltage window in which a rechargeable battery cell can be operated reversibly, i.e., repeatedly charged and discharged.

The organic sodium-ion cells known from prior art contain an electrolyte which comprises an organic solvent or solvent mixture and a conductive salt dissolved therein. The conductive salt is a sodium salt such as sodium perchlorate (NaClO₄) or sodium hexafluorophosphate (NaPF₆). The organic solvent mixture can, for example, be propylene carbonate (PC). Solvent mixtures may contain ethylene carbonate (EC), diethyl carbonate (DEC) or dimethyl carbonate (DMC). For example, the following mixtures are used: EC: DEC, EC: PC or EC: DMC.

Because of the use of the organic solvent or solvent mixture, such sodium-ion cells are also referred to as organic sodium-ion cells.

A suitable negative electrode for organic sodium-ion cells, for example, consists of carbon in the hard carbon modification. Hard carbon has a capacity of 300 mAh/g and a first cycle efficiency of 80%.

Positive electrodes of the organic sodium-ion cell can consist of layered oxides such as NaMeOₓ or polyanionic compounds such as phosphates (NaMePO₄), pyrophosphates (Na₂MeP₂O₇) and fluorophosphates (Na₂Me(PO)₄F), with “Me” representing a transition metal.

Sodium is a very electronegative metal (−2.71 V vs. a standard hydrogen electrode (SHE), which leads to the generation of a very high cell voltage against a positive electrode. The reduction of the organic electrolyte takes place at the negative electrode. This reductive decomposition is irreversible. No organic solvents are thermodynamically stable towards sodium or towards sodium stored in carbon. However, many solvents form a passivation film on the electrode surface of the negative electrode. This film spatially separates the solvent from the electrode, but is ionically conductive and thus allows the passage of sodium ions. The passivation film, the so-called “Solid Electrolyte Interphase” (SEI), provides stability to the system, which allows for the production of organic sodium-ion cells. During the formation of the SEI, sodium is integrated into the passivation film. This process is irreversible, which results in a loss of capacity. This irreversible loss of capacity, also known as cover layer capacity, depends on the electrolyte formulation and electrodes used. In organic sodium-ion cells, the electrolyte decomposition and the formation of sodium-ion-containing layers often continue during the continued operation of the organic sodium-ion cell and are responsible for the loss of capacity and thus for a shorter useful life of the organic sodium-ion cell. Therefore, organic sodium-ion cells are problematic in terms of their stability and long-term operational reliability. Safety risks are also caused in particular by the flammability of the organic solvent or solvent mixture. If an organic sodium-ion cell catches fire or even explodes, the organic solvent in the electrolyte forms a combustible material. Another disadvantage of organic sodium-ion cells is the decomposition of the organic components of the SEI layer and the associated release of toxic gases. This results in a further heating of the cell. In order to avoid such safety risks, additional measures must be taken. These measures include, in particular, very precise control of the charging and discharging processes of the organic sodium-ion cell. However, the additional measures are considered detrimental with regard to any possible marketing.

A further development known from the prior art provides for the use of an electrolyte based on sulfur dioxide (SO₂) instead of an organic electrolyte for rechargeable battery cells. Rechargeable battery cells which contain an SO₂-based electrolyte have, among other things, a high ionic conductivity. In the context of this disclosure, the term “SO₂-based electrolyte” is to be understood as meaning an electrolyte that not only contains SO₂ as an additive at a low concentration, but in which the mobility of the ions of the conductive salt contained in the electrolyte, the salt effecting the charge transport, is at least partially, largely or even fully ensured by SO₂. The SO₂ thus serves as a solvent for the conductive salt. The conductive salt can form a liquid solvate complex with the gascous SO₂, with the SO₂ being bound and the vapor pressure being noticeably reduced compared to pure SO₂. This results in electrolytes with a low vapor pressure. Such electrolytes based on SO₂ have the advantage of non-combustibility compared to the organic electrolytes described above. Safety risks which are due to the flammability of the electrolyte can be ruled out this way.

Mainly SO₂-based electrolytes with the composition LiAlCl₄*xSO₂ are used. Sodium conductive salts were considered as well, however. U.S. Pat. No. 4,891,281 (referred to as [V1]) describes studies on lithium and sodium conductive salts, e.g., LiAlCl₄ and NaAlCl₄, in SO₂-based electrolytes. The document indicates, however, that electrolytes containing the conductive salt NaAlCl₄ have a poorer conductivity than electrolytes containing the conductive salt LiAlCl₄. EP 2 860 799 A1 (referred to as [V2]) discloses a rechargeable alkali-ion battery with an SO₂-based electrolyte with the composition NaAlCl₄*xSO₂. One example shows this electrolyte in combination with a sodium-metal anode and a carbon-containing cathode, where SO₂ is oxidized or reduced as the active electrode material during the operation of the battery cell.

EP 2 860 811 A1 (referred to as [V3]) discloses a battery cell with an electrolyte having the composition NaAlCl₄*xSO₂, a metal-chloride-containing cathode and an anode with a sodium-containing inorganic material.

In addition to the alkali-tetrachloroaluminate-conductive salts commonly used in SO₂ electrolytes (e.g., LiAlCl₄*xSO₂ or NaAlCl₄*xSO₂), EP 3 772 129 A1 (referred to as [V4]) discloses a new group of conductive salts for SO₂-based electrolytes. These conductive salts consist of an anion with four substituted hydroxy groups grouped around the central atom boron or aluminum and a cation consisting of the active metal of the cell. All of the examples relate to experiments exclusively with lithium salts of this type.

A problem with SO₂-based electrolytes is that many conductive salts, especially those known for organic sodium-ion cells, are not soluble in SO₂. Consequently, such conductive salts are unsuitable for use in rechargeable sodium-ion cells with an SO₂-based electrolyte.

As a result, the object of this disclosure is to provide a rechargeable battery cell which, compared to the rechargeable battery cells known from the prior art:
does not provide for the use of lithium,
contains an SO₂-based electrolyte which has good solubility for conductive salts, and is therefore a good ionic conductor and electronic insulator so that ionic transport can be facilitated and self-discharge can be kept to a minimum;
contains an SO₂-based electrolyte that is also inert to other rechargeable battery cell components such as separators, electrode materials and cell packaging materials;
has a wide electrochemical window so that oxidative electrolyte decomposition does not occur at the positive electrode;
has a stable cover layer on the negative electrode, wherein the cover layer capacity should be low and no further reductive electrolyte decomposition should occur on the negative electrode during further operation;
is robust against various abuses such as electrical, mechanical or thermal;
contains an SO₂-based electrolyte which, from an economically viable point of view, contains inexpensive and easily obtainable raw materials.
the conducting element of the negative electrode can also be a discharge element made of aluminum.

Such rechargeable battery cells should in particular also have very good electrical energy and performance data, high operational reliability and service life, in particular a large number of usable charging and discharging cycles, without the electrolytes decomposing during operation of the rechargeable battery cell.

The object of this disclosure was surprisingly achieved by a rechargeable battery cell with the features of claim 1. Claims 2 to 20 describe advantageous developments of the rechargeable battery cell according to this disclosure. Further advantageous developments of the rechargeable battery cell according to this disclosure can be found in the description, the examples and the drawings.

A rechargeable battery cell according to this disclosure comprises an active metal, at least one positive electrode, at least one negative electrode, a housing and an electrolyte, with the active metal being sodium. The electrolyte is based on SO₂ and contains at least one first conductive salt with the formula (I).

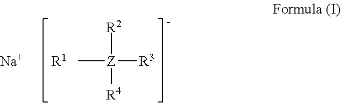

In formula (I), the substituents R¹, R² and R³ are independently selected from the group consisting of a halogen atom, a hydroxy group and a chemical group —OR⁵. The substituent R⁴ is selected from the group consisting of a hydroxy group and a chemical group —OR⁵, wherein the substituent R⁵ is selected from the group consisting of C₁-C₁₀ alkyl, C₂-C₁₀ alkenyl, C₂-C₁₀ alkynyl, C₃-C₁₀ cycloalkyl, C₆-C₁₄ aryl and C₅-C₁₄ heteroaryl, wherein the aliphatic, cyclic, aromatic and heteroaromatic groups may be unsubstituted or substituted. At least two of the substituents R¹, R², R³ and R⁴ can jointly form a chelate ligand which is coordinated to Z. Furthermore, it is either aluminum or boron.

The phrase “chelate ligand which is formed jointly by at least two of the substituents R¹, R², R³ and R⁴ and is coordinated to Z” is to be understood within the meaning of this disclosure that at least two of the substituents R¹, R², R³ and R⁴ can be bridged to one another, wherein this bridging of two substituents leads to the formation of a bidentate chelate ligand. For example, the chelate ligand can be bidentate according to the formula —O—R⁵—O—. To form this chelate ligand —OR⁵—O—, the first substituent R¹ can, from a structural point of view, preferably be an OR⁵ group and the second substituent R² can preferably be a hydroxy group, which, in their bridged state, are connected to one another by forming a chemical bond and therefore have the aforementioned formula —O—R⁵—O—. Such chelate ligands can, for example, have the following structural formulas:

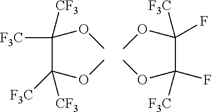

The chelate ligand coordinates to the central atom Z to form a chelate complex. In the case of the bidentate chelate ligand —OR⁵—O—, the two oxygen atoms coordinate to the central atom Z. Such chelate complexes can be prepared synthetically as in Example 1 described below. The term “chelate complex” stands for complex compounds in which a multidentate ligand (has more than one free electron pair) occupies at least two coordination sites (bonding sites) of the central atom. The chelate ligand can also be multidentate if three or four of the substituents R¹, R², R³ and R⁴ are bridged to each other.

The SO₂-based electrolyte used in the rechargeable battery cell according to this disclosure contains SO₂ not only as an additive in a low concentration, but also in concentrations at which the mobility of the ions of the first conductive salt, which is contained in the electrolyte and causes charge transport, is at least partially, largely or even completely guaranteed by the SO₂. The first conductive salt is dissolved in the electrolyte and exhibits very good solubility therein. It can form a liquid solvate complex with the gaseous SO₂. the SO₂ being bound in said complex. In this case, the vapor pressure of the liquid solvate complex drops significantly compared to pure SO₂ and electrolytes with a low vapor pressure result. However, it is also within the scope of this disclosure that, depending on the chemical structure of the first conductive salt according to formula (I), no reduction in vapor pressure can occur during the production of the inventive electrolyte. In the latter case, it is preferred that the inventive electrolyte is produced at low temperature or under pressure. The electrolyte can also contain a plurality of conductive salts of formula (I) which differ from one another in their chemical structure. For the purposes of this disclosure, the term “C₁-C₁₀ alkyl” includes linear or branched saturated hydrocarbon groups having one to ten carbon atoms. These include, in particular, methyl, ethyl, n-propyl, isopropyl, n-butyl, sec-butyl, isobutyl, tert-butyl, n-pentyl, isopentyl, 2,2-dimethylpropyl, n-hexyl, isohexyl, 2-ethylhexyl, n-heptyl, isoheptyl, n-octyl, isooctyl, n-nonyl, n-decyl and the like.

In the context of this disclosure, the term “C₂-C₁₀ alkenyl” includes unsaturated linear or branched hydrocarbon groups having two to ten carbon atoms, the hydrocarbon groups having at least one C—C double bond. These include in particular ethenyl, 1-propenyl, 2-propenyl, 1-n-butenyl, 2-n-butenyl, isobutenyl, 1-pentenyl, 1-hexenyl, 1-heptenyl, 1-octenyl, 1-nonenyl, 1-decenyl and the like.

In the context of this disclosure, the term “C₂-C₁₀ alkynyl” includes unsaturated linear or branched hydrocarbon groups having two to ten carbon atoms, the hydrocarbon groups having at least one C—C triple bond. These include in particular ethynyl, 1-propynyl, 2-propynyl, 1-n-butynyl, 2-n-butynyl, isobutynyl, 1-pentynyl, 1-hexynyl, 1-heptynyl, 1-octynyl, 1-nonynyl, 1-decynyl and the like.

In the context of this disclosure, the term “C₃-C₁₀ cycloalkyl” includes cyclic, saturated hydrocarbon groups having three to ten carbon atoms. These include, in particular, cyclopropyl, cyclobutyl, cyclopentyl, cyclohexyl, cycloheptyl, cyclohexyl, cyclononyl and cyclodecanyl.

In the context of this disclosure, the term “C₆-C₁₄ aryl” includes aromatic hydrocarbon groups having six to fourteen carbon atoms in the ring. These include in particular phenyl (C₆H₅ group), naphthyl (C₁₀H₇ group) and anthracyl (C₁₄H₉ group).

In the context of this disclosure, the term “C₅-C₁₄ heteroaryl” includes aromatic hydrocarbon groups with five to fourteen ring hydrocarbon atoms in which at least one hydrocarbon atom is replaced or exchanged by a nitrogen, oxygen or sulfur atom. These include in particular pyrrolyl, furanyl, thiophenyl, pyrridinyl, pyranyl, thiopyranyl and the like. All of the aforementioned hydrocarbon groups are each bonded to the central atom according to formula (I) via the oxygen atom.

In all the definitions of the terms already mentioned, it is also within the meaning of this disclosure that the aliphatic, cyclic, aromatic and heteroaromatic residues/groups can be unsubstituted or substituted. During the substitution, one or more hydrogen atoms of the aliphatic, cyclic, aromatic and heteroaromatic residues/groups are replaced by an atom, such as fluorine or chlorine, or a chemical group, such as CF₃.

The rechargeable battery cell according to this disclosure uses inexpensive and readily available sodium as the active metal and thus exhibits the first major advantage over the lithium-ion cells known from prior art.

Compared to rechargeable battery cells with SO₂-based electrolytes with sodium conductive salts known from the prior art, the rechargeable battery cell according to this disclosure with such an electrolyte has the advantage that the first conductive salt of the formula (I) contained therein has a higher oxidation stability and consequently exhibits essentially no decomposition at higher cell voltages. This electrolyte is stable against oxidation, preferably at least up to an upper potential of 3.6 volts, more preferably at least up to an upper potential of 3.8 volts, more preferably at least up to an upper potential of 4.0 volts, more preferably at least up to an upper potential of 4.2 volts, more preferably at least to an upper potential of 4.4 volts and particularly preferably at least to an upper potential of 4.6 volts. Thus, when using the rechargeable cell according to this disclosure comprising such an electrolyte, there is little or no electrolyte decomposition within the working potentials, i.e., in the range between the end-of-charge voltage and the end-of-discharge voltage of both electrodes of the rechargeable battery cell.

The service life of the rechargeable battery cell according to this disclosure containing this electrolyte is significantly longer than rechargeable battery cells containing electrolytes known from prior art.

Furthermore, the rechargeable battery cell according to this disclosure with such an electrolyte is also resistant to low temperatures. The conductivity of the electrolyte at low temperatures is sufficient for operating a battery cell.

These advantages of the rechargeable battery cell according to this disclosure comprising the electrolyte outweigh the disadvantage that arises from the fact that the first conductive salt according to formula (I) has a significantly larger anion size compared to the sodium conductive salts known from prior art. This higher anion size leads to a lower conductivity of the first conductive salt according to formula (I) compared to the conductivity of NaAlCl₄.

### Negative Electrode

Advantageous developments of the rechargeable battery cell according to this disclosure with regard to the negative electrode are described below:

One advantageous development of the rechargeable battery cell according to this disclosure provides that the active material of the negative electrode consists of metallic sodium and/or at least one sodium-storing material selected from the group consisting of insertion materials, adsorption materials, alloy-forming materials and conversion materials.

According to one advantageous development of the rechargeable battery cell according to this disclosure, the active material of the negative electrode is metallic sodium. This means that sodium is also the active metal of the rechargeable battery. It is deposited on the conducting element of the negative electrode when the rechargeable battery cell is charged. This means that the negative electrode contains not only the metallic sodium as the active material but also a conducting element. This conducting element serves to facilitate the required electronically conductive connection of the active material of the negative electrode. For this purpose, the conducting element is in contact with the active material involved in the electrode reaction of the negative electrode. When the rechargeable battery cell is discharged, the metallic sodium is converted into sodium ions, which migrate from the negative electrode to the positive electrode.

A further advantageous development of the rechargeable battery cell according to this disclosure with metallic sodium as the active material of the negative electrode provides that the electronically conductive conducting element of the negative electrode comprises metallic sodium even before the rechargeable battery cell is recharged for the first time. This metallic sodium was applied to the conducting element before the battery cell was assembled and incorporated into the battery cell together with the conducting element or was deposited on the conducting element of the negative electrode by a preceding initialization charging process before the operation of the battery cell, i.e., before the first charging and discharging process.

A further advantageous development of the battery cell according to this disclosure with metallic sodium as the active material of the negative electrode provides that the conducting element of the negative electrode is at least partially formed from a sodium-storing material. In such a further development, a portion of the sodium resulting from the electrode reaction is initially stored in the electronically conductive conducting element made of the sodium-storing material when the battery cell is charged. When the battery cell is charged further, metallic sodium is deposited on the electronically conductive conducting element. During discharge, the metallic sodium is completely or partially dissolved and enters the host matrix of the active material of the positive electrode in the form of ions.

According to a further advantageous development of the rechargeable battery cell according to this disclosure, the active material of the negative electrode consists of at least one sodium-storing material which is selected from the group consisting of insertion materials, adsorption materials, alloy-forming materials and conversion materials.

The term “insertion materials” is to be understood within the meaning of this disclosure to refer to materials into which the active metal ions can be intercalated during the charging of the rechargeable battery cell and from which the active metal ions can be deintercalated during the discharging of the rechargeable battery cell. This means that the electrode processes can take place not only on the surface of the negative electrode, but also inside the negative electrode.

In the context of this disclosure, the term “adsorption materials” refers to adsorption materials where ions are deposited on the surface, in contrast to insertion materials, which have a structure into which ions of the active metal can be intercalated and deintercalated during the operation of the sodium-ion cell. In many materials, insertion and adsorption occur simultaneously as well.

For the purposes of this disclosure, the term “alloy-forming materials” refers to materials which are generally metals and metal alloys as well as their oxides which form an alloy with the active metal, such as sodium, with this alloy formation taking place in or on the negative electrode and being substantially reversible. In contrast to insertion materials, the active metal in the alloys is not embedded in an already existing structure. Rather, the active metal is embedded by means of phase transformation processes, which can lead to a sodium-containing, binary end product, for example, when sodium is used as the active metal. The active material may expand during the alloy formation.

For the purposes of this disclosure, the term “conversion materials” refers to materials which undergo a chemical conversion or transformation during the electrode processes, which leads to the reversible formation of a chemical bond between the active metal and the active material.

A further advantageous development of the rechargeable battery cell according to this disclosure provides that the sodium-storing material may preferably be the insertion material containing carbon. For the purposes of this disclosure, the term “insertion materials made of carbon” refers to materials made of the element carbon which fall under the term “insertion materials” defined above.

A further advantageous development of the rechargeable battery cell according to this disclosure provides that the insertion material containing carbon is selected from the group consisting of hard carbon, soft carbon, graphene or heteroatom-doped carbons. Hard carbon can be synthesized from the carbonization of a variety of precursors such as biomass, lignin, cellulose and many types of polymers. Carbonaceous materials from fossil fuels (coke, pitch, etc.) are generally considered soft (graphitizable) and describe the group of soft carbons. Heteroatom-doped carbons are carbons that contain additional atoms, for example, nitrogen, oxygen, sulfur or phosphorus, in their structure or on the surface in addition to the carbon atoms.

A further advantageous development of the rechargeable battery cell according to this disclosure provides that the insertion material containing carbon is hard carbon.

A further advantageous development of the rechargeable battery cell according to this disclosure provides that the insertion material containing carbon is soft carbon.

A further advantageous development of the rechargeable battery cell according to this disclosure provides that the insertion material containing carbon is graphene.

A further advantageous development of the rechargeable battery cell according to this disclosure provides that the insertion material containing carbon is heteroatom-doped carbon.

A further advantageous development of the rechargeable battery cell according to this disclosure provides that the sodium ions can also be adsorbed on the surface.

A further advantageous development of the rechargeable battery cell according to this disclosure provides that the sodium-storing material of the negative electrode consists of at least one carbon-free insertion material, such as sodium titanates, in particular Na₂Ti₃O₇ or NaTi₂(PO₄)₃. For the purposes of this disclosure, the term “carbon-free insertion materials” refers to materials made of an element other than carbon, which fall under the term “insertion materials” defined above.

A further advantageous development of the rechargeable battery cell according to this disclosure provides that the sodium-storing material of the negative electrode consists of at least one sodium alloy-forming material. For the purposes of this disclosure, the term “sodium alloy-forming material” refers to alloy-forming materials as defined above which form an alloy with sodium.

Sodium-storing metals and metal alloys (e.g., Sn, Sb) can be used as alloy-forming materials. Alternatively, sulfides or oxides of sodium-storing metals and metal alloys (e.g., SnSₓ, SbSₓ, oxide glasses of Sn, Sb and the like) can be used as alloy-forming materials.

A further advantageous development of the rechargeable battery cell according to this disclosure provides that the anode active materials which form alloys with sodium contain sodium even before they are used in a battery cell. This measure reduces the capacity losses, e.g., due to the formation of a cover layer in the first cycle.

A further advantageous development of the rechargeable battery cell according to this disclosure provides that the sodium-storing material of the negative electrode consists of at least one sodium-storing material which is a conversion material as defined above. The conversion material can be selected from the group consisting of sulfides, oxides, selenides and fluorides of the metals Ti, V, Cr, Mn, Fe, Co, Ni, Cu and Zn, in particular iron sulfides (FeSₓ), iron selenides (FeSeₓ), iron fluorides (FeFₓ), iron oxides (FeOₓ), cobalt oxides (CoOₓ), nickel oxides (NiOₓ) and copper oxides (CuOₓ).

A further advantageous development of the rechargeable battery cell according to this disclosure provides that the negative electrode consists of a combination of the sodium-storing materials described above. For example, a combination of tin (Sb) and/or tin sulfide (SnSₓ) and hard carbon could be used.

A further advantageous development of the rechargeable battery cell according to this disclosure provides that the negative electrode is porous, the porosity preferably being at most 50%, more preferably at most 45%, more preferably at most 40%, more preferably at most 35%, more preferably at most 30%, more preferably at most 20% and particularly preferably at most 10%. The porosity represents the void volume in relation to the total volume of the negative electrode, with the void volume being formed by so-called pores or cavities. This porosity increases the internal surface area of the negative electrode. Furthermore, the porosity reduces the density of the negative electrode and thus its weight. The individual pores of the negative electrode can preferably be completely filled with the electrolyte during operation.

A further advantageous development of the battery cell according to this disclosure provides that the negative electrode has a conducting element. This means that the negative electrode also includes a conducting element in addition to the active material or insertion material. This conducting element serves to facilitate the required electronically conductive connection of the active material of the negative electrode. For this purpose, the conducting element is in contact with the active material involved in the electrode reaction of the negative electrode. This conducting element can be planar in the form of a thin metal sheet or a thin metal foil. The thin metal foil preferably has a perforated or net-like structure. The planar conducting element can also consist of a metal-coated plastic film. These metal coatings have a thickness in the range from 0.1 μm to 20 μm. The negative electrode active material is preferably coated onto the surface of the thin metal sheet, thin metal foil or metal-coated plastic film. The active material can be applied to the front and/or the back of the planar conducting element. Such planar conducting elements have a thickness in the range from 5 μm to 50 μm. A thickness of the planar conducting element in the range from 10 μm to 30 μm is preferred. When using planar conducting elements, the negative electrode can have a total thickness of at least 20 μm, preferably at least 40 μm and particularly preferably at least 60 μm. The maximum thickness is at most 200 μm, preferably at most 150 μm and particularly preferably at most 100 μm. The area-specific capacity of the negative electrode, relative to the coating on one side, is preferably at least 0.5 mAh/cm² when using a planar conducting element, with the following values being more preferred, in this order: 1 mAh/cm², 3 mAh/cm², 5 mAh/cm², 10 mAh/cm², 15 mAh/cm², 20 mAh/cm². Furthermore, there is also the possibility for the conducting element to be three-dimensional in the form of a porous metal structure, in particular in the form of a metal foam. The term “three-dimensional porous metal structure” refers to any structure made of metal that extends not only over the length and width of the flat electrode, like the thin metal sheet or metal foil, but also over its thickness dimension. The three-dimensional porous metal structure is porous such that the active material of the negative electrode can be incorporated into the pores of the metal structure. The loading of the negative electrode has to do with the amount of active material incorporated or applied. If the conducting element is three-dimensional in the form of a porous metal structure, in particular in the form of a metal foam, then the negative electrode preferably has a thickness of at least 0.2 mm, more preferably at least 0.3 mm, more preferably at least 0.4 mm, more preferably at least 0.5 mm, and particularly preferably at least 0.6 mm. In this case, the thickness of the electrodes is significantly greater compared to negative electrodes used in organic sodium-ion cells. One further advantageous embodiment provides that the area-specific capacity of the negative electrode when using a three-dimensional conducting element, in particular in the form of a metal foam, is preferably at least 2.5 mAh/cm², the following values being more preferred in this order: 5 mAh/cm², 15 mAh/cm², 25 mAh/cm², 35 mAh/cm², 45 mAh/cm², 55 mAh/cm², 65 mAh/cm², 75 mAh/cm². If the conducting element is three-dimensional and in the form of a porous metal structure, in particular in the form of a metal foam, the amount of active material of the negative electrode, i.e., the loading of the electrode, relative to its surface area, is at least 10 mg/cm², preferably at least 20 mg/cm², more preferably at least 40 mg/cm², more preferably at least 60 mg/cm², more preferably at least 80 mg/cm², and particularly preferably at least 100 mg/cm². This loading of the negative electrode has a positive effect on the charging process and the discharging process of the rechargeable battery cell.

The conducting element of the negative electrode can be made of nickel or copper, for example. The potential of the active metal sodium is slightly higher than the potential of the active metal lithium, which is used in lithium-ion batteries, for example. This means that an aluminum arrester can also be used for sodium cells without the sodium alloying with the aluminum, unlike lithium.

In one further advantageous development of the battery cell according to this disclosure, the negative electrode has at least one binding agent. This binding agent is preferably a fluorinated binding agent, in particular a polyvinylidene fluoride and/or a terpolymer formed from tetrafluoroethylene, hexafluoropropylene, and vinylidene fluoride. However, it can also be a binding agent which comprises a polymer built up from monomeric structural units of a conjugated carboxylic acid or from the alkali metal, alkaline earth metal, or ammonium salt of this conjugated carboxylic acid or from a combination thereof. Furthermore, the binding agent can also comprise a polymer based on monomeric styrene and butadiene structural units. In addition, the binding agent can also be a binding agent from the group of carboxymethyl celluloses. The binding agent is in the negative electrode preferably in a concentration of at most 20 wt. %, more preferably at most 15 wt. %, more preferably at most 10 wt. %, more preferably at most 7 wt. %, more preferably at most 5 wt. %, and particularly preferably at most 2 wt. % based on the total weight of the negative electrode.

In a further advantageous development of the battery cell according to this disclosure, the negative electrode comprises at least one conductivity additive. The conductivity additive should preferably have a low weight, high chemical resistance and a high specific surface area; examples of conductivity additives are particulate carbon (carbon black, Super P, acetylene black), fibrous carbon (CarbonNanoTubes CNT, carbon (nano) fibers), finely distributed graphite and graphene (nanosheets).

### Electrolyte

Advantageous developments of the rechargeable battery cell are described below with regard to the SO₂-based electrolyte.

A first advantageous development of the rechargeable battery cell according to this disclosure provides that the substituents R¹, R², R³ and R⁴ of the first conductive salt have, independently of one another, the structure of the chemical group —OR⁵, wherein R⁵ is selected from the group consisting of C₁-C₁₀ alkyl, C₂-C₁₀ alkenyl, C₂-C₁₀ alkynyl, C₃- C₁₀ cycloalkyl, C₆-C₁₄ aryl and C₅-C₁₄ heteroaryl, wherein the aliphatic, cyclic, aromatic and heteroaromatic groups can be unsubstituted or substituted.

A further advantageous development of the rechargeable battery cell according to this disclosure provides that the substituent R⁵ is selected from the group consisting of:
C₁-C₆ alkyl, preferably C₂-C₄ alkyl, particularly preferably 2-propyl, methyl and ethyl;
C₂-C₆ alkenyl, preferably C₂-C₄ alkenyl, particularly preferably ethenyl and propenyl;
C₂-C₆ alkynyl; preferably C₂-C₄ alkynyl;
C₃-C₆ cycloalkyl;
phenyl; and
C₅-C₇ heteroaryl;
wherein the aliphatic, cyclic, aromatic and heteroaromatic groups may be unsubstituted or substituted.

The definitions of the terms “C₁-C₆ alkyl,” “C₂-C₆ alkenyl,” “C₂-C₆ alkynyl,” “C₃-C₆cycloalkyl” and “heteroaryl” are the same as defined above.

A further advantageous development of the rechargeable battery cell according to this disclosure provides that, in order to improve the solubility of the first conductive salt in the SO₂-based electrolyte, at least a single atom or a group of atoms of the substituent R⁵ is substituted by a halogen atom, in particular a fluorine atom, or by a chemical group, wherein the chemical group is selected from the group consisting of C₁-C₄ alkyl, C₂-C₄ alkenyl, C₂-C₄ alkynyl, phenyl, benzyl, and fully and partially halogenated, in particular fully and partially fluorinated, C₁-C₄ alkyl, C₂-C₄ alkenyl, C₂-C₄ alkynyl, phenyl and benzyl. The chemical groups C₁-C₄ alkyl, C₂-C₄ alkenyl, C₂-C₄ alkynyl, phenyl and benzyl have the same properties or chemical structures as the hydrocarbon groups described above.

A particularly high solubility of the first conductive salt in the SO₂-based electrolyte can be achieved if at least one atom group of the substituent R⁵ is preferably a CF₃ group or an OSO₂CF₃ group.

A further advantageous development of the rechargeable battery cell according to this disclosure provides that the substituents R¹, R², R³ and R⁴ are hydroxy groups (—OH). The hydrogen atom (H) of these hydroxy groups can be substituted by a chemical group selected from the group consisting of C₁-C₄ alkyl, C₂-C₄ alkenyl, C₂-C₄ alkynyl, phenyl, benzyl, and fully and partially halogenated, in particular fully and partially fluorinated, C₁-C₄ alkyl, C₂-C₄ alkenyl, C₂-C₄ alkynyl, phenyl and benzyl. The chemical groups C₁-C₄ alkyl, C₂-C₄ alkenyl, C₂-C₄ alkynyl, phenyl and benzyl have the same properties or chemical structures as the hydrocarbon groups described above and fall under the above definitions.

A further advantageous development of the rechargeable battery cell according to this disclosure provides that the first conductive salt is selected from the group consisting of:

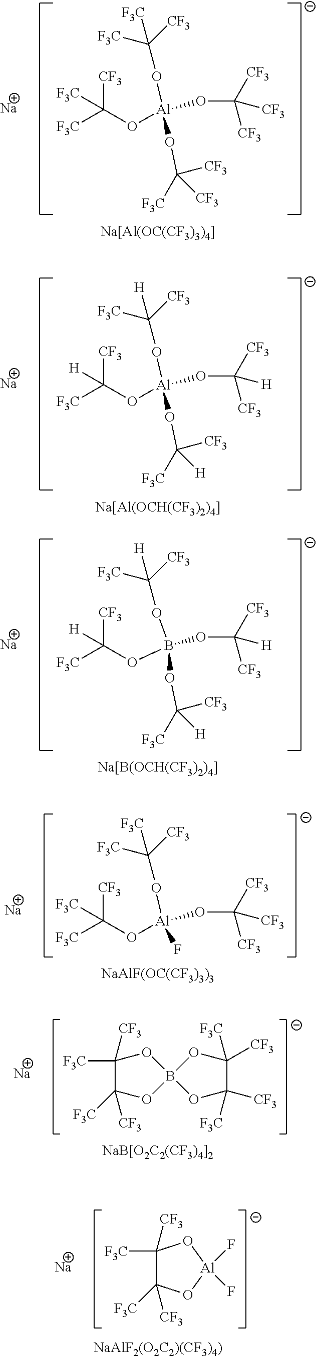

In order to adjust the conductivity and/or other properties of the electrolyte to a desired value, in one further advantageous embodiment of the inventive rechargeable battery cell the electrolyte has at least one second conductive salt which differs from the first conductive salt according to formula (I). This means that, in addition to the first conductive salt, the electrolyte may contain one or even more second conductive salts which differ from the first conductive salt in terms of their chemical composition and their chemical structure.

In one further advantageous embodiment of the inventive rechargeable battery cell, the second conductive salt is an alkali metal compound, in particular a sodium compound. The alkali metal compound or the sodium compound is selected from the group formed by an aluminate, a halide, an oxalate, a borate, a phosphate, an arsenate and a gallate. The second conductive salt is preferably a sodium tetrahalogenoaluminate, in particular NaAlCl₄.

Furthermore, in a further advantageous embodiment of the rechargeable battery cell according to this disclosure, the electrolyte contains at least one additive. This additive is preferably selected from the group consisting of vinylene carbonate and its derivatives, vinyl ethylene carbonate and its derivatives, methyl ethylene carbonate and its derivatives, sodium (bisoxalato) borate, sodium difluoro (oxalato) borate, sodium tetrafluoro (oxalato) phosphate, sodium oxalate, 2-vinylpyridine, 4-vinylpyridine, cyclic exomethylene carbonates, sultones, cyclic and acyclic sulfonates, acyclic sulfites, cyclic and acyclic sulfinates, organic esters of inorganic acids, acyclic and cyclic alkanes, said acyclic and cyclic alkanes having a boiling point of at least 36° C. at 1 bar, aromatic compounds, halogenated cyclic and acyclic sulfonylimides, halogenated cyclic and acyclic phosphate esters, halogenated cyclic and acyclic phosphines, halogenated cyclic and acyclic phosphites, halogenated cyclic and acyclic phosphazenes, halogenated cyclic and acyclic silylamines, halogenated cyclic and acyclic halogenated esters, halogenated cyclic and acyclic amides, halogenated cyclic and acyclic anhydrides, and halogenated organic heterocyclics.

Based on the total weight of the electrolyte composition, the electrolyte has the following composition in a further advantageous development of the rechargeable battery cell:
(i) 5 to 99.4 wt. % sulfur dioxide,
(ii) 0.6 to 95 wt. % of the first conductive salt,
(iii) 0 to 25 wt. % of the second conductive salt and
(iv) 0 to 10 wt. % of the additive.

As already mentioned above, the electrolyte can contain not only a first conductive salt according to formula (I) and a second conductive salt, but also a plurality of first conductive salts according to formula (I) and a plurality of second conductive salts. In the latter case, the aforementioned percentages also include a plurality of first conductive salts and a plurality of second conductive salts. The molar concentration of the first conductive salt is in the range of 0.01 mol/L to 10 mol/L, preferably 0.05 mol/L to 10 mol/L, more preferably 0.1 mol/L to 6 mol/L, and particularly preferably 0.2 mol/L to 3.5 mol/L based on the total volume of the electrolyte.

A further advantageous development of the rechargeable battery cell according to this disclosure provides that the electrolyte contains at least 0.1 mole SO₂, preferably at least 1 mole SO₂, more preferably at least 5 moles SO₂, more preferably at least 10 moles SO₂, and particularly preferably at least 20 moles SO₂ per mole of conductive salt. The electrolyte can also contain very high molar proportions of SO₂, the preferred upper limit being 2600 moles SO₂ per mole of conductive salt, and upper limits of 1500, 1000, 500 and 100 moles SO₂ per mole of conductive salt in this order being more preferred. The term “per mole of conductive salt” relates to all conductive salts contained in the electrolyte. SO₂-based electrolytes having such a concentration ratio between SO₂ and the conductive salt have the advantage that they can dissolve a larger amount of conductive salt compared to the electrolytes known from the prior art which are based, for example, on an organic solvent mixture. Within the scope of this disclosure, it was found that, surprisingly, an electrolyte with a relatively low concentration of conductive salt is advantageous despite the associated higher vapor pressure, in particular with regard to its stability over many charging and discharging cycles of the rechargeable battery cell. The concentration of SO₂ in the electrolyte affects its conductivity. Thus, by choosing the SO₂ concentration, the conductivity of the electrolyte can be adapted to the planned use of a rechargeable battery cell operated with this electrolyte.

The total content of SO₂ and the first conductive salt can be greater than 50 weight percent (wt. %) of the weight of the electrolyte, preferably greater than 60 wt. %, more preferably greater than 70 wt. %, more preferably greater than 80 wt. %, more preferably greater than 85 wt. %, more preferably greater than 90 wt. %, more preferably greater than 95 wt. % or more preferably greater than 99 wt. %.

The electrolyte can contain at least 5 wt. % SO₂ relative to the total amount of the electrolyte contained in the rechargeable battery cell, values of 20 wt. % SO₂, 40 wt. % SO₂ and 60 wt. % SO₂ being more preferred. The electrolyte can also contain up to 95 wt. % SO₂, with maximum values of 80 wt. % SO₂ and 90 wt. % SO₂. in this order, being preferred. It is within the scope of this disclosure that the electrolyte preferably has only a small percentage or even no percentage of at least one organic solvent. The proportion of organic solvents in the electrolyte present in the form of, for example, one or a mixture of a plurality of solvents, may preferably be at most 50 wt. % of the weight of the electrolyte. Lower proportions of at most 40 wt. %, at most 30 wt. %, at most 20 wt. %, at most 15 wt. %, at most 10 wt. %, at most 5 wt. % or at most 1 wt. % of the weight of the electrolyte are particularly preferred. More preferably, the electrolyte is free of organic solvents. Due to the low proportion of organic solvents or even their complete absence, the electrolyte is either hardly or not at all flammable. This increases the operational safety of a rechargeable battery cell operated with such an SO₂-based electrolyte.

Based on the total weight of the electrolyte composition, the electrolyte has the following composition in a further advantageous development of the rechargeable battery cell:
(i) 5 to 99.4 wt. % sulfur dioxide,
(ii) 0.6 to 95 wt. % of the first conductive salt,
(iii) 0 to 25 wt. % of the second conductive salt,
(iv) 0 to 10 wt. % of the additive and
(v) 0 to 50 wt. % of an organic solvent.

### Positive Electrode

Advantageous developments of the rechargeable battery cell according to this disclosure with regard to the positive electrode are described below:

The first advantageous development of the rechargeable battery cell according to this disclosure provides that the positive electrode is preferably chargeable at least up to an upper potential of 3.6 volts, more preferably at least up to an upper potential of 3.8 volts, more preferably at least up to an upper potential of 4.0 volts, more preferably at least up to an upper potential of 4.2 volts, more preferably at least to an upper potential of 4.4 volts and particularly preferably at least to an upper potential of 4.6 volts.

In a further advantageous development of the rechargeable battery cell according to this disclosure, the positive electrode contains at least one active material. This active material can store sodium of the active metal and during operation of the battery cell can release and take up the sodium of the active metal again.

In a further advantageous development of the rechargeable battery cell according to this disclosure, the positive electrode contains at least one intercalation compound. In the context of this disclosure, the term “intercalation compound” is to be understood as meaning a subcategory of the insertion materials described above. This intercalation compound acts as a host matrix that has interconnected vacancies. The ions of the active metal can diffuse into these vacancies during the discharge process of the rechargeable battery cell and can be intercalated there. Minor or no structural changes occur in the host matrix as a result of this intercalation of the active metal ions.

In a further advantageous development of the rechargeable battery cell according to this disclosure, the positive electrode contains at least one conversion compound as an active material. As used herein, the term “conversion compounds” means materials that form other materials during electrochemical activity; i.e., during the charging and discharging of the battery cell, chemical bonds are broken and re-formed. Structural changes occur in the matrix of the conversion compound during the uptake or release of the active metal ions.

In one further advantageous refinement of the inventive rechargeable battery cell, the active material has the composition Na_{M}′_{y}M″_{z}Oₐ, wherein
M′ is at least one metal selected from the group consisting of the elements Ti, V, Cr, Mn, Fe, Co, Ni, Cu and Zn;
M″ is at least one element selected from the group that is formed from the elements of groups 2, 3, 4, 5, 6, 7, 8, 9, 10, 11, 12, 13, 14, 15 and 16 of the periodic table of elements;
x and y, independently of one another, are numbers greater than 0;
z is a number greater than or equal to 0; and
a is a number greater than 0.

The indices y and z in the composition NaₓM′_{y}M″_{z}Oₐ refer to all of the metals and elements represented by M′ or M″. For example, if M′ comprises two metals M′¹ and M′², then the following applies for the index y: y=y1+y2, wherein y1 and y2 represent the indices of the metals M′¹ and M′². The indices x, y, z, and a must be selected in such a way that there is charge neutrality within the composition. Examples of compounds in which M′ comprises two metals are sodium nickel manganese cobalt oxides of the composition NaₓNi_{y1}Mn_{y2}Co_{z}O₂ where M′¹=Ni, M′²=Mn and M″=Co. Examples of compounds in which z=0, that is to say which have no further metal or element M″, are sodium cobalt oxides NaₓCo_{y}Oₐ.

For example, if M″ comprises two elements, on the one hand a metal M″¹ and on the other hand phosphorus as M″², then for the index z, the following applies: z=z1+z2, where z1 and z2 are the indices of the metal M″¹ and of phosphorus (M″²). The indices x, y, z, and a must be selected in such a way that there is charge neutrality within the composition. Examples of compounds in which M″ comprises a metal M″¹ and phosphorus as M″² are sodium iron manganese phosphates NaₓFe_{y}Mn_{z1}P_{z2}O₄ where M′=Fe, M″¹=Mn und M″²=P and z2=1. In another composition, M″ may comprise two non-metals, for example, fluorine as M″¹ and sulfur as M″². Examples of such compounds are the sodium iron fluorosulfates NaₓFe_{y}F_{z1}S_{z2}O₄ with M′=Fe, M″₁=F and M″₂=P.

A further advantageous development of the rechargeable battery cell according to this disclosure provides that the compounds NaₓM′_{y}M″_{z}Oₐ have the structures of layered oxides. M′ or M″ can be two or more metals M′¹, M′², M′³ etc. or M″¹, M″², M″³ etc. Examples of such compounds are NaNi_{0.5}Mn_{0.2}Ti_{0.3}O₂, Na_{0.90}Cu_{0.22}Fe_{0.30}Mn_{0.48}O₂, Na_{2/3}Ni_{2/3}Te_{1/3}O₂, Na_{2/3}Fe_{1/2}Mn_{1/2}O₂, NaₓMnO₂, NaFe_{1/2}Mn_{1/2}O₂, Na (Fe_{1/3}Mn_{1/3}Ni_{1/3})O₂, and Na[Ni_{0.4}Fe_{0.2}Mn_{0.2}Ti_{0.2}]O₂. Preferred are compounds in which M′ consists of the metals nickel and manganese and M″ is cobalt, so that the compound has the formula NaₓNi_{y1}Mn_{y2}Co_{z}Oₐ, where y1 and y2 are, independently of each other, numbers greater than 0. This can include compositions of the formula Naₓ[Ni_{y1}Mn_{y2}CO_{z}]O₂ (NMC), i.e., sodium nickel manganese cobalt oxides that have the structure of layered oxides. Examples of these sodium nickel manganese cobalt oxide active materials are Na [Ni_{1/3}Mn_{1/3}Co_{1/3}]O₂ and Na_{0.6}[Ni_{0.25}Mn_{0.5}Co_{0.25}]O₂.

A further advantageous development of the rechargeable battery cell according to this disclosure provides that the composition has the formula NaₓM′_{y}M″_{z}O₄. These compounds are spinel structures. For the example, M′ may be cobalt and M″ may be manganese. In this case, the active material is sodium cobalt manganese oxide (NaCoMnO₄).

In a further advantageous development, the compound has the composition NaₓM′_{y}M″¹_{z1}M″²_{z2}Oₐ, where M″¹ and M″² are each at least one element selected from the group consisting of the elements of groups 2, 3, 4, 5, 6, 7, 8, 9, 10, 11, 12, 13, 14, 15 and 16 of the Periodic Table of the Elements and where M″² together with Oₐ form at least one polyanion structural unit. The polyanion structural unit can, for example, consist of structures of the compositions (M″²O₄)ⁿ⁻, (M″²ₘO₃ₘ₊₁)ⁿ⁻ or (M″²O₃)ⁿ⁻, where m and n are, independently from each other, numbers greater than 0. Examples of such anions are (SO₄)²⁻, (PO₄)³⁻, (SiO₄)²⁻, (AsO₄)³⁻, (MoO₄)²⁻, (WO₄)²⁻, (P₂O₇)⁴⁻, (CO₃)²⁻ and (BO₃)³⁻.

If M″² is the element phosphorus, the compound with the composition NaₓM′_{y}M″_{z1}M″_{z2}Oₐ is a so-called sodium metal phosphate. Examples of these compounds are Na₃V₂(PO₄)₃, NaVPO₄F, Na₂CoP₂O₇, Na₄Ni₃(PO₄)₂P₂O₇, Na₂MnPO₄F and Na₂MnP₂O₇. If M″² is the element sulfur, the compound with the composition NaₓM′_{y}M″_{z1}M″_{z2}Oₐ is a so-called sodium metal sulfate. Examples of these compounds are NaFeSO₄F and NaFe₂(PO₄)(SO₄)₂. The second compound is a compound with two polyanion structural units. If M″² is the element silicon, the compound with the composition NaₓM′_{y}M″_{z1}M″_{z2}Oₐ is a so-called sodium metal silicate. An example of these compounds is Na₂FeSiO₄.

In a further advantageous development of the rechargeable battery cell according to this disclosure, the active material has the composition NaₓM′_{y}[Fe(CN)₆]ₐ. nH₂O, where M′is at least one metal selected from the group consisting of the elements Ti, V, Cr, Mn, Fe, Co, Ni, Cu and Zn. M′ can be two or more metals M′¹, M′², M′³ etc. In that case, the following applies for the index y: y=y1+y2, wherein y1 and y2 are the indices of the metals M′¹ and M′². n is a number greater than or equal to zero. x, all indices y (y, y1, y2 etc.) and a are, independently from each other, numbers greater than 0. This type of compound is hexacyanoferrate, also known as “Prussian blue” and “Prussian white”. Examples of such compounds are Na₂NiFe(CN)₆, FeFe(CN)₆·4H₂O, Na_{0.61}FeFe(CN)₆, Na_{1.89}Mn[Fe(CN)₆]_{0.97} and NaNi_{0.3}Mn_{0.7}Fe(CN)₆.

In a further advantageous development of the rechargeable battery cell according to this disclosure, the positive electrode contains, as the active material, at least one active material representing a conversion compound. Conversion compounds undergo a solid-state redox reaction during the uptake of the active metal, for example, sodium, the crystal structure of the material changing during the reaction. This occurs while chemical bonds are breaking and recombining. Completely reversible reactions of conversion compounds may include the following:
Type A: MX_{z}↔+yNa M+zNa_{(y/z)}X
Type B: X↔+yNa Na_{y}X

The conversion compounds are selected from the group consisting of sulfides, oxides, selenides and fluorides of the metals Ti, V, Cr, Mn, Fe, Co, Ni, Cu and Zn, in particular iron sulfides (FeSₓ), iron selenides (FeSeₓ), iron fluorides (FeFₓ), iron oxides (FeOₓ), cobalt oxides (CoOₓ), nickel oxides (NiOₓ) and copper oxides (CuOₓ).

A further advantageous development of the rechargeable battery cell according to this disclosure provides that the positive electrode contains at least one metal compound. This metal compound is selected from the group consisting of a metal oxide, a metal halide and a metal phosphate. The metal of this metal compound is preferably a transition metal with atomic numbers 22 to 28 in the periodic table of the elements, in particular cobalt, nickel, manganese or iron.

A further advantageous development of the rechargeable battery cell according to this disclosure provides that the positive electrode contains at least one metal compound which has the chemical structure of layered oxide, a spinel, a conversion compound or a polyanionic compound.

It is within the scope of this disclosure that the positive electrode contains at least one of the described compounds or a combination of the compounds as active material. A combination of the compounds means a positive electrode which contains at least two of the materials described.

A further advantageous development of the battery cell according to this disclosure provides that the positive electrode has a conducting element. This means that the positive electrode also includes a conducting element in addition to the active material. This conducting element serves to facilitate the required electronically conductive connection of the active material of the positive electrode. For this purpose, the conducting element is in contact with the active material involved in the electrode reaction of the positive electrode.

This conducting element can be planar in the form of a thin metal sheet or a thin metal foil. The thin metal foil preferably has a perforated or net-like structure. The planar conducting element can also consist of a metal-coated plastic film. These metal coatings have a thickness in the range from 0.1 μm to 20 μm. The positive electrode active material is preferably applied to the surface of the thin metal sheet, the thin metal foil or the metal-coated plastic film. The active material can be applied to the front and/or the back of the planar conducting element. Such planar conducting elements have a thickness in the range from 5 μm to 50 μm. A thickness of the planar conducting element in the range from 10 μm to 30 μm is preferred. When using planar conducting elements, the positive electrode can have a total thickness of at least 20 μm, preferably at least 40 μm and particularly preferably at least 60 μm. The maximum thickness is at most 200 μm, preferably at most 150 μm and particularly preferably at most 100 μm. The area-specific capacity of the positive electrode, based on the coating on one side, is preferably at least 0.5 mAh/cm² when using a planar conducting element, with the following values being more preferred in this order: 1 mAh/cm², 3 mAh/cm², 5 mAh/cm², 10 mAh/cm², 15 mAh/cm², 20 mAh/cm².

Furthermore, there is also the possibility for the conducting element of the positive electrode to be three-dimensional and in the form of a porous metal structure, in particular in the form of a metal foam. The three-dimensional porous metal structure is porous such that the active material of the positive electrode can be incorporated into the pores of the metal structure. The loading of the positive electrode has to do with the amount of active material incorporated or applied. If the conducting element is three-dimensional in the form of a porous metal structure, in particular in the form of a metal foam, then the positive electrode preferably has a thickness of at least 0.2 mm, more preferably at least 0.3 mm, more preferably at least 0.4 mm, more preferably at least 0.5 mm, and particularly preferably at least 0.6 mm. A further advantageous embodiment provides that the area-specific capacity of the positive electrode, when using a three-dimensional conducting element, in particular in the form of a metal foam, is preferably at least 2.5 mAh/cm², with the following values being preferred in this order: 5 mAh/cm², 15 mAh/cm², 25 mAh/cm², 35 mAh/cm², 45 mAh/cm², 55 mAh/cm², 65 mAh/cm², 75 mAh/cm². If the conducting clement is three-dimensional and in the form of a porous metal structure, in particular in the form of a metal foam, the amount of active material of the positive electrode, i.e., the loading of the electrode, relative to its surface area, is at least 10 mg/cm², preferably at least 20 mg/cm², more preferably at least 40 mg/cm², more preferably at least 60 mg/cm², more preferably at least 80 mg/cm², and particularly preferably at least 100 mg/cm². This loading of the positive electrode has a positive effect on the charging process and the discharging process of the rechargeable battery cell.

In one further advantageous refinement of the inventive battery cell, the positive electrode has at least one binding agent. This binding agent is preferably a fluorinated binding agent, in particular a polyvinylidene fluoride and/or a terpolymer formed from tetrafluoroethylene, hexafluoropropylene, and vinylidene fluoride. However, it can also be a binding agent which comprises a polymer built up from monomeric structural units of a conjugated carboxylic acid or from the alkali metal, alkaline earth metal, or ammonium salt of this conjugated carboxylic acid or from a combination thereof. Furthermore, the binding agent can also comprise a polymer based on monomeric styrene and butadiene structural units. In addition, the binding agent can also be a binding agent from the group of carboxymethyl celluloses. The binding agent is in the positive electrode preferably in a concentration of at most 20 wt. %, more preferably at most 15 wt. %, more preferably at most 10 wt. %, more preferably at most 7 wt. %, more preferably at most 5 wt. %, and particularly preferably at most 2 wt. % based on the total weight of the positive electrode.

### Structure of the Rechargeable Battery Cell

Advantageous developments of the rechargeable battery cell according to this disclosure are described below with regard to its structure:

In order to further improve the function of the rechargeable battery cell, a further advantageous development of the rechargeable battery cell according to this disclosure provides that the rechargeable battery cell comprises a plurality of negative electrodes and a plurality of high-voltage electrodes which are stacked alternately in the housing. In this case, the positive electrodes and the negative electrodes are preferably each electrically separated from one another by separators. However, the rechargeable battery cell can also be designed as a wound cell in which the electrodes consist of thin layers that are wound up together with a separator material. On one hand, the separators separate the positive electrode and the negative electrode spatially and electrically and, on the other hand, they are permeable, inter alia, to the ions of the active metal. In this way, large electrochemically active surfaces are created which enable a correspondingly high current yield.

The separator can be formed from a fleece, a membrane, a woven fabric, a knitted fabric, an organic material, an inorganic material or a combination thereof. Organic separators can consist of unsubstituted polyolefins (for example, polypropylene or polyethylene), partially to fully halogen-substituted polyolefins (for example, partially to fully fluorine-substituted, in particular PVDF, ETFE, PTFE), polyesters, polyamides or polysulfones. Separators containing a combination of organic and inorganic materials are, for example, glass fiber fabrics in which the glass fibers are provided with a suitable polymeric coating. The coating preferably contains a fluorine-containing polymer such as polytetrafluoroethylene (PTFE), ethylene tetrafluoroethylene (ETFE), perfluoroethylene propylene (FEP), THV (terpolymer of tetrafluoroethylene, hexafluoroethylene and vinylidene fluoride), a perfluoroalkoxy polymer (PFA), aminosilane, polypropylene or polyethylene (PE). The separator can also be folded in the housing of the rechargeable battery cell, for example, in the form of a so-called “Z-Folding”. With this Z-Folding, a strip-shaped separator is folded in a Z-like manner through or around the electrodes. Furthermore, the separator can also be designed as separator paper.

It is also within the scope of this disclosure for the separator to be in the form of an enclosure, with each high-voltage electrode or each negative electrode being enclosed by the enclosure. The enclosure can be formed from a fleece, a membrane, a woven fabric, a knitted fabric, an organic material, an inorganic material or a combination thereof.

Enclosing the positive electrode results in more even ion migration and ion distribution in the rechargeable battery cell. The more uniform the ion distribution, in particular in the negative electrode, the higher the possible loading of the negative electrode with active material and consequently the higher the usable capacity of the rechargeable battery cell. At the same time, risks associated with uneven loading and the resulting deposition of the active metal can be avoided. These advantages have an effect above all when the positive electrodes of the rechargeable battery cell are enclosed by the enclosure.

The surface area dimensions of the electrodes and the enclosure can preferably be matched to one another in such a way that the outer dimensions of the enclosure of the electrodes and the outer dimensions of the non-enclosed electrodes match at least in one dimension.

The surface area extent of the enclosure can preferably be greater than the surface area extent of the electrode. In this case, the enclosure extends beyond a boundary of the electrode. Two layers of the enclosure covering the electrode on both sides may therefore be connected to one another at the edge of the positive electrode by an edge connector.

In a further advantageous embodiment of the rechargeable battery cell according to this disclosure, the negative electrodes have an enclosure, whereas the positive electrodes have no enclosure.

Further advantageous properties of this disclosure are described and explained in more detail below using figures, examples and experiments.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 is a sectional view of a first exemplary embodiment of an inventive rechargeable battery cell;

FIG. 2 is a detail from an electron micrograph of the three-dimensional porous structure of the metal foam of the first exemplary embodiment from FIG. 1;

FIG. 3 is a sectional view of a second exemplary embodiment of an inventive rechargeable battery cell;

FIG. 4 shows a detail of the second exemplary embodiment from FIG. 3;

FIG. 5 is an exploded view of a third embodiment of the inventive rechargeable battery cell;

FIG. 6 shows a third exemplary embodiment of the rechargeable battery cell according to this disclosure in an exploded view;

FIG. 7 shows the potential in [V] of a test cell with a three-electrode arrangement during the charging and discharging of the negative electrodes with hard carbon as the active electrode materials as a function of the capacity;

FIG. 8 shows the potential in [V] of a test cell with a three-electrode arrangement during the repeated charging and discharging of the negative electrodes with metallic sodium as the active electrode material as a function of time;

FIG. 9 shows the potential curve in volts as a function of the capacity of cycle 1 and cycle 2 of a test cell with a three-electrode arrangement with sodium cobalt oxide as the active material of the positive electrode; and

FIG. 10 shows the conductivity of the electrolyte Na1 in [mS/cm] and the reference electrolyte on the basis of the concentration of the conductive salts.

### DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

It shall be understood for purposes of this disclosure and appended claims that, regardless of whether the phrases “one or more” or “at least one” precede an element or feature appearing in this disclosure or claims, such element or feature shall not receive a singular interpretation unless it is made explicit herein. By way of non-limiting example, the terms “positive electrode,” “negative electrode,” “conductive salt,” and “binder,” to name just a few, should be interpreted wherever they appear in this disclosure and claims to mean “at least one” or “one or more” regardless of whether they are introduced with the expressions “at least one” or “one or more.” All other terms used herein should be similarly interpreted unless it is made explicit that a singular interpretation is intended.

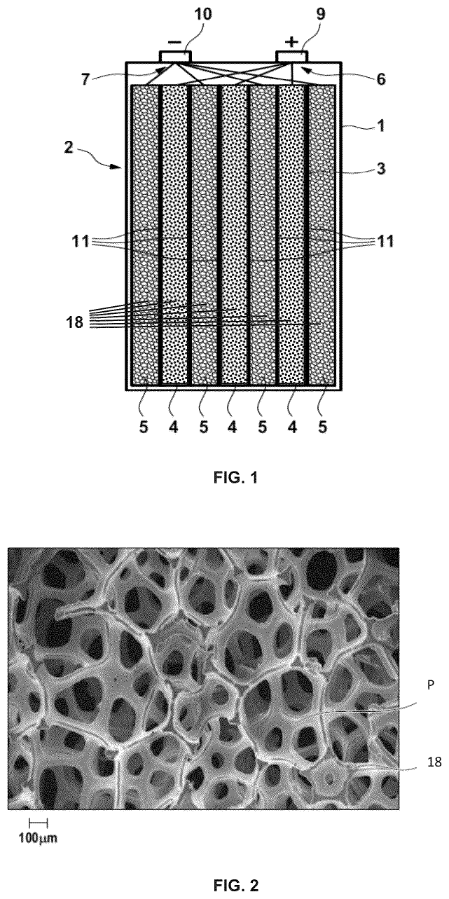

FIG. 1 is a sectional view of a first exemplary embodiment of a rechargeable battery cell 2 according to this disclosure. This rechargeable battery cell 2 is designed as a prismatic cell and has a housing 1, inter alia. This housing 1 encloses an electrode arrangement 3 which includes three positive electrodes 4 and four negative electrodes 5. The positive electrodes 4 and the negative electrodes 5 are stacked alternately in the electrode assembly 3. However, the housing 1 can also accommodate more positive electrodes 4 and/or negative electrodes 5. It is generally preferred for the number of negative electrodes 5 to be greater by one than the number of positive electrodes 4. As a result, the outer end faces of the electrode stack are formed by the electrode surfaces of the negative electrodes 5. The electrodes 4, 5 are connected to corresponding connection contacts 9, 10 of the rechargeable battery cell 2 via electrode connections 6, 7. The rechargeable battery cell 2 is filled with an SO₂-based electrolyte in such a way that the electrolyte penetrates as completely as possible into all the pores or cavities, in particular within the electrodes 4, 5. The electrolyte is not visible in FIG. 1. In the present embodiment, the positive electrodes 4 contain an intercalation compound as active material. This intercalation compound is NaCoO₂.

In the present embodiment, the electrodes 4, 5 are embodied flat, i.e., as layers with a smaller thickness in relation to the extension of their surface. They are each separated from one another by separators 11. The housing 1 of the rechargeable battery cell 2 is essentially cuboid, the electrodes 4, 5 and the walls of the housing 1 shown in a sectional view extend perpendicular to the plane of the drawing and are shaped essentially straight and flat.

The electrodes 4, 5 also each have a conducting element which enables the required electronically conductive connection of the active material of the respective electrode. This conducting element is in contact with the active material involved in the electrode reaction of the respective electrode 4, 5 (not shown in FIG. 1). The conducting clement is in the form of a porous metal foam 18. The metal foam 18 extends across the thickness of the electrodes 4, 5. The active material of the positive electrodes 4 and negative electrodes 5 is incorporated into the pores of this metal foam 18 so that it evenly fills the pores of the latter over the entire thickness of the metal structure. To improve the mechanical strength, the positive electrodes 4 contain a binding agent. This binding agent is a fluoropolymer. The negative electrodes 5 contain carbon as an active material in a form suitable as an insertion material for taking up sodium ions. The structure of the negative electrode 5 is similar to that of the positive electrode 4.

FIG. 2 shows an electron micrograph of the three-dimensional porous structure of the metal foam 18 of the first exemplary embodiment from FIG. 1. The scale indicated shows that the pores P have an average diameter of more than 100 μm, that is, they are relatively large. This metal foam is a metal foam made of nickel.

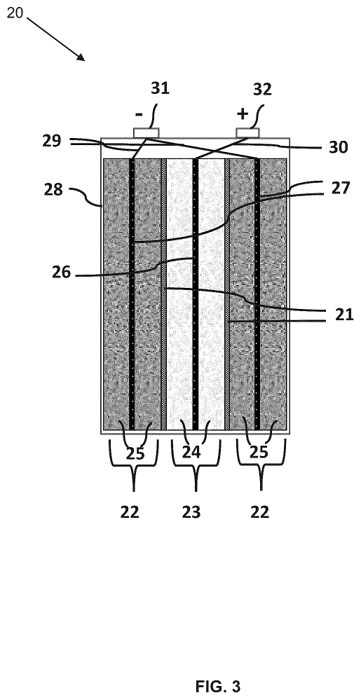

FIG. 3 is a sectional view of a second embodiment of an inventive rechargeable battery cell 20. This second embodiment is distinguished from the first embodiment shown in FIG. 1 in that the electrode arrangement includes one positive electrode 23 and two negative electrodes 22. They are each separated from one another by separators 21 and enclosed by a housing 28. The positive electrode 23 has a conducting element 26 in the form of a planar metal film to which the active material 24 of the positive electrode 23 is applied on both sides. The negative electrodes 22 also include a conducting element 27 in the form of a planar metal film to which the active material 25 of the negative electrode 22 is applied on both sides. Alternatively, the planar conducting elements of the edge electrodes, that is to say the electrodes which complete the electrode stack, may only be coated with active material on one side. The non-coated side faces the wall of the housing 28. The electrodes 22, 23 are connected to corresponding connection contacts 31, 32 of the rechargeable battery cell 20 via electrode connections 29, 30.

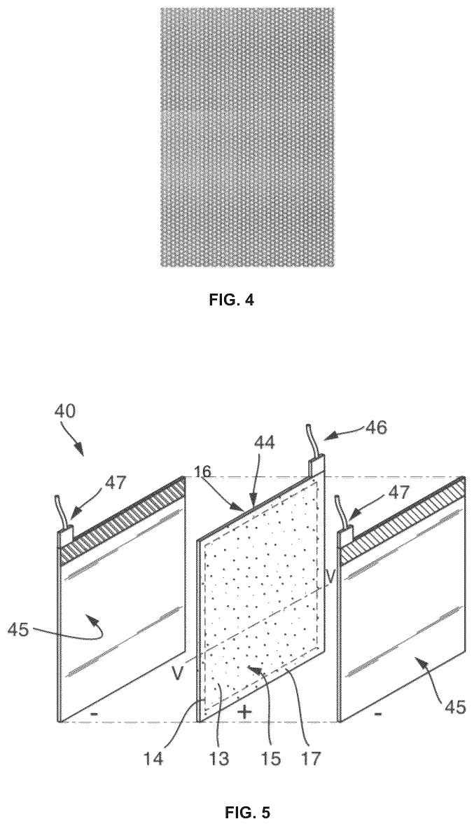

FIG. 4 shows the planar metal film, which serves as a conducting element 26, 27 for the positive electrodes 23 and the negative electrodes 22 in the second exemplary embodiment from FIG. 3. This metal film has a perforated or net-like structure with a thickness of 20 μm.

FIG. 5 shows an exploded view of a third exemplary embodiment of an inventive rechargeable battery cell 40. This third exemplary embodiment is distinguished from the two exemplary embodiments explained above in that the positive electrode 44 is enclosed by a covering 13. In this case, a surface extension of the covering 13 is greater than a surface extension of the positive electrode 44, the limit 14 of which is drawn in as a dashed line in FIG. 5. Two layers 15, 16 of the covering 13, which enclose the positive electrode 44 on both sides, are connected to one another by an edge connection 17 at the peripheral edge of the positive electrode 44. The two negative electrodes 45 are not enclosed. The electrodes 44 and 45 can be contacted via the electrode connections 46 and 47.

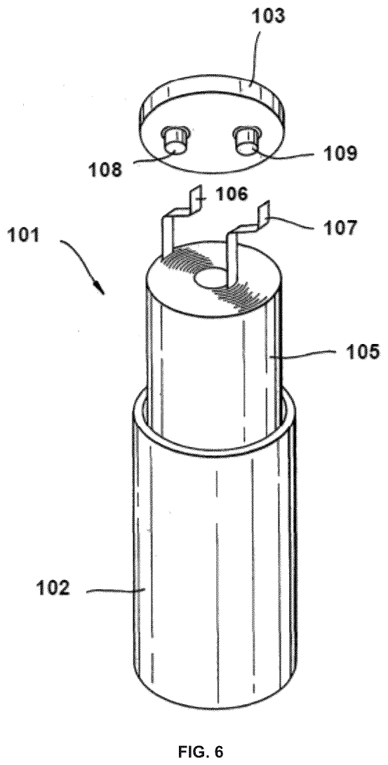

FIG. 6 shows a third embodiment of a rechargeable battery cell 101 according to this disclosure in an exploded view. The essential structural elements of a battery cell 101 with a wound electrode arrangement are shown. In a cylindrical housing 102 with a cover part 103, there is an electrode arrangement 105 which is wound from a web-like starting material. The web consists of a plurality of layers including a positive electrode, a negative electrode, and a separator running between the electrodes, the separator electrically and mechanically insulating the electrodes from one another but being sufficiently porous or ionically conductive to allow the necessary ion exchange. In this way, large electrochemically active surfaces are created which enable a correspondingly high current yield. The positive electrode has a conducting element in the form of a planar metal film to which a homogeneous mixture of the active material of the positive electrode is applied on both sides. The negative electrode also comprises a conducting element in the form of a planar metal film to which a homogeneous mixture of the active material of the negative electrode is applied on both sides.

The cavity of the housing 102, insofar as it is not occupied by the electrode arrangement 105, is filled with an electrolyte (not shown). The positive and negative electrodes of the electrode arrangement 105 are connected via corresponding terminal lugs 106 for the positive electrode and 107 for the negative electrode to the terminal contacts 108 for the positive electrode and 109 for the negative electrode, the lugs enabling the rechargeable battery cell 101 to be electrically connected. As an alternative to the electrical connection of the negative electrode shown in FIG. 6, using the terminal lug 107 and the terminal contact 109, the electrical connection of the negative electrode may also be accomplished via the housing 102.

### Example 1: Preparation of a Reference Electrolyte

For the experiments described below, an SO₂-based reference electrolyte was prepared. For this purpose, a compound Lil shown below was first prepared as a conductive salt according to a preparation process described in the following document [V5]:
[V5] “I. Krossing, Chem. Eur. J. 2001, 7, 490

This compound 1 comes from the family of polyfluoroalkoxyaluminates and was prepared in hexane according to the following reaction equation starting from LiAlH₄ and the corresponding alcohol R—OH with R¹═R²═R³═R⁴.

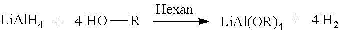

This resulted in the formation of the compound Li1 shown below with the following molecular or structural formula:

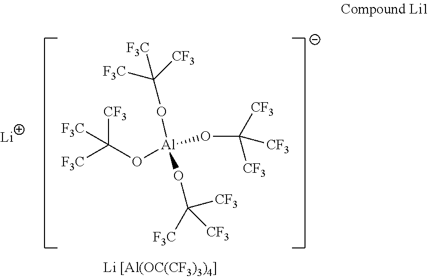

To prepare the reference electrolyte, this compound Li1 was dissolved in SO₂. The concentration of the conductive salt in the reference electrolyte was 0.6 mol/L.

### Example 2: Production of an Embodiment of an SO₂-Based Electrolyte for a Battery Cell

For the experiments described below, an embodiment of the SO₂-based electrolyte was prepared. For this purpose, the compound Na1 shown below was first prepared as a conductive salt according to formula (I) pursuant to a preparation process described in the following document [V6]:
[V6] PJ Malinowski et al, Dalton Trans., 2020, 49, 7766-7773

The conductive salt according to formula (I) was prepared in hexane according to the following reaction equation starting from NaAlH₄ and the corresponding alcohol R—OH with R¹═R²═R³═R⁴.

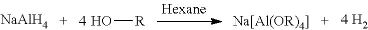

This resulted in the formation of the compound Na1 with the molecular or structural formula shown below:

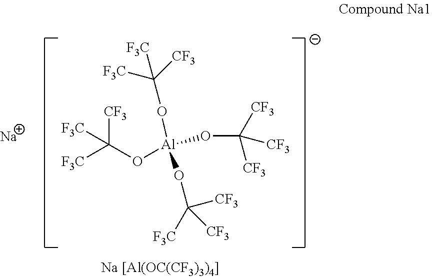

The compound Na1 was then dissolved in SO₂ at low temperature or under pressure according to the process steps 1 to 4 listed below:
1) Present the respective compound Na1 in a pressure flask with riser tube,
2) Evacuate the pressure piston,
3) Introduce liquid SO₂ and
4) Repeat steps 2+3 until the target amount of SO₂ has been added.

This created the electrolyte Na1. The concentration of the Na1 compounds in the electrolyte was 0.6 mol/L (molar concentration based on 1 liter of electrolyte), unless otherwise stated in the experiment description. The experiments described below were carried out with the electrolyte Na1 and the reference electrolyte.

### Experiment 1: Behavior of Negative Electrodes Made of Hard Carbon

The experiments were carried out in a test cell with a three-electrode arrangement (working electrode, counter electrode and reference electrode) with metallic sodium as the counter and reference electrode. The working electrode was an electrode with an active material made of hard carbon. The composition of the electrode was 96 wt. % hard carbon and a total of 4 wt. % of the binders CMC and SBR. The conducting element was an aluminum foil. The half cells were filled with the electrolyte Na1.

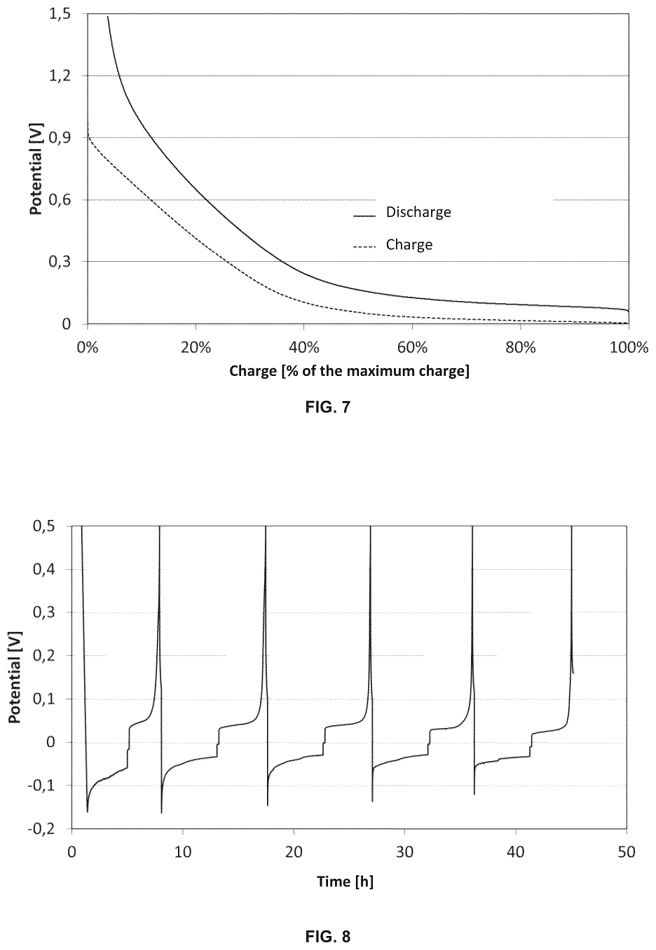

The half-cells were charged at a charge/discharge rate of 0.1 C up to a potential of 0.005 volts and discharged to a potential of 1.5 volts. FIG. 7 shows the potentials of the charge curve and discharge curve for the fifth cycle of the half-cell.

The dashed curve corresponds to the potentials of the charging curve and the solid curve corresponds to the potentials of the discharging curve.

The charging and discharging curves show typical battery behavior with a good cycle efficiency of over 95%.

### Experiment 2: Behavior of Negative Electrodes Made of Metallic Sodium

The experiments were carried out in a test cell with a three-electrode arrangement (working electrode, counter electrode and reference electrode) with metallic sodium as the counter and reference electrode. The working electrode was an aluminum foil. The half cells were filled with the electrolyte Na1.

The metallic sodium was deposited (charging) and dissolved (discharging) several times. For this purpose, 0.25 mAh/cm² of sodium was first deposited. Then, the discharge took place up to a discharge potential of 0.5 volts. The charge and discharge rates were 0.1 mA/cm² each. FIG. 8 shows the potential curve of five charge/discharge cycles over time.

The deposition and dissolution of metallic sodium show a uniform progression over the five cycles.

### Experiment 3: Test Cells with Sodium Cobalt Oxide of the Composition Na_{0.7}CoO₂ as Active Electrode Material

To test sodium cobalt oxide as an active electrode material for the positive electrode in the electrolyte Na1, a test cell with a three-electrode arrangement (working electrode, counter electrode and reference electrode) was prepared in an experiment. The active material of the positive electrode (cathode) consisted of sodium cobalt oxide of composition Na_{0.7}CoO₂. The composition of the total positive electrode was 94 wt. % Na_{0.7}CoO₂ and ₄ wt. % of the binder PVDF and ₂ wt. % of carbon black. The conducting element was an aluminum foil. The counter electrode and the reference electrode consisted of metallic sodium. The test cell was filled with the electrolyte Na1.

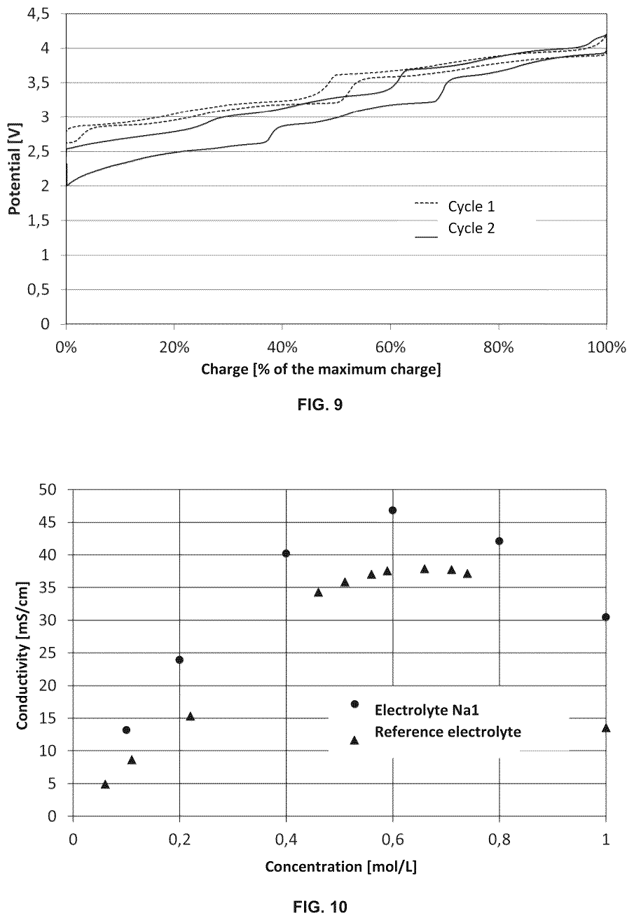

The test cell was charged at a charge rate of 0.1 C to an upper potential of 4.2 V. The discharge then took place at a discharge rate of 0.1 C up to a discharge potential of 2.0 volts. FIG. 9 shows the potential curve of the first two charge/discharge cycles in volts [V] as a function of the charge in % of the maximum charge.

The potential curves show stable charging and discharging behavior. The curve is typical for this type of electrode material.

### Experiment 4: Determination of the Conductivity of the Electrolyte Na1 in Comparison to the Reference Electrolyte

To determine the conductivity, the Na1 electrolyte was prepared with different concentrations of the compound Na1. For each concentration of the compound, the conductivity of the electrolytes was determined with the help of a conductive measurement method. After having checked the temperature, a four-electrode sensor was held in the solution and measurements in a measuring range of 0.02-500 mS/cm were taken. The identical measurements were performed with the reference electrolyte.

FIG. 10 shows the conductivity of the electrolyte Na1 as a function of the concentration of the compound Na1. For comparison purposes, the conductivity of the reference electrolyte is plotted as a function of the concentration of the corresponding Li compound (see [V4]).

A maximum conductivity can be seen at a concentration of the compound Na1 of 0.6 mol/L with a high conductivity value of approx. 48 mS/cm. In comparison, the reference electrolyte has a maximum conductivity of approximately 38 mS/cm at a concentration of the compound Li1 of 0.6 mol/L-0.7 mol/L.

The electrolyte Na1 with the conductive salt Na1 therefore has a better conductivity than the reference electrolyte with the corresponding lithium compound Li1. This was extremely surprising since, on the one hand, in prior art SO₂-based electrolytes, the lithium compound had shown better conductivity than the sodium compound, as already described above (see [V1] U.S. Pat. No. 4,891,281). On the other hand, the sodium ion is larger than the lithium ion, so that better conductivity is expected for lithium electrolytes as well. The results of the experiments summarized in Table 1 show the surprising results regarding the conductivities.

TABLE 1
Conductivities

| | Conductivity | |
|---|---|---|
| Conductive Salt | [mS/cm] | Source |
| LiAlCl₄* 3.5 SO₂ | 100 | [V1] |
| NaAlCl₄* 2.8 SO₂ | 80 | [V1] |
| Reference electrolyte | 38 | Maximum FIG. 10 |
| (conductive salt Li1) | | |
| Electrolyte Na1 | 47 | Maximum FIG. 10 |
| (conductive salt Na1) | | |

In comparison, the organic electrolytes known from prior art, such as LP30 (1 M LiPF6/EC-DMC (1:1 by weight)) have a conductivity of only approx. 10 mS/cm.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

What is claimed is:

1. A rechargeable battery cell, comprising:
an active metal, wherein the active metal is sodium;
at least one positive electrode;
at least one negative electrode;
a housing; and
an electrolyte;
wherein the electrolyte is based on SO₂ and comprises at least one first conductive salt which has the formula (I) 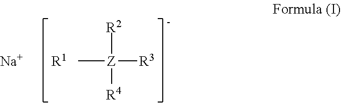
wherein
the substituents R¹, R² und R³ are selected independently from each other from the group consisting of a halogen atom, a hydroxy group and a chemical group —OR⁵;
the substituent R⁴ is selected from the group consisting of a hydroxy group and a chemical group —OR⁵;
the substituent RS is selected from the group consisting of a C₁-C₁₀ alkyl, C₂-C₁₀ alkenyl, C₂-C₁₀ alkynyl, C₃-C₁₀ cycloalkyl, C₆-C₁₄ aryl and C₅-C₁₄ heteroaryl, wherein the aliphatic, cyclic, aromatic and heteroaromatic groups may be unsubstituted or substituted;
Z is aluminum or boron; and
at least two of the substituents R¹, R², R³ and R⁴ can jointly form a chelate ligand which is coordinated to Z.

2. The rechargeable battery cell according to claim 1, wherein the active metal sodium is stored in the negative electrode as:
metallic sodium; and/or
in at least one sodium-storing material selected from the group consisting of insertion materials, adsorption materials, alloy-forming materials and conversion materials.

3. The rechargeable battery cell according to claim 2, wherein the sodium-storing material is an insertion material containing carbon selected from the group consisting of hard carbon, soft carbon, graphene and heteroatom-doped carbons.

4. The rechargeable battery cell according to claim 2, wherein the sodium-storing material is a carbon-free insertion material, preferably a sodium titanate, in particular Na₂Ti₃O₇ or NaTi₂(PO₄)₃.

5. The rechargeable battery cell according to claim 2, wherein the sodium-storing material is a sodium alloy-forming material selected from the group consisting of:
sodium-storing metals and metal alloys, preferably Sn, Sb, or
sulfides and oxides of sodium-storing metals and metal alloys, preferably SnSₓ, SbSₓ, oxide glasses of Sn, Sb.

6. The rechargeable battery cell according to claim 2, wherein the sodium-storing material is a conversion material which is selected from the group consisting; of sulfides, oxides, selenides and fluorides of the metals Ti, V, Cr, Mn, Fe, Co, Ni, Cu and Zn, preferably iron sulfides (FeSₓ), iron selenides (FeSeₓ), iron fluorides (FeFₓ), iron oxides (FeOₓ), cobalt oxides (CoOₓ), nickel oxides (NiOₓ) and copper oxides (CuOₓ).

7. The rechargeable battery cell according to claim 2, wherein the negative electrode comprises at least one sodium alloy-forming anode material in combination with at least one insertion material containing carbon.

8. The rechargeable battery cell according to claim 1, wherein the positive electrode contains as active material at least one compound which preferably has the composition NaₓM′_{y}M″_{z}Oₐ, wherein:
M′is at least one metal selected from the group consisting of the elements Ti, V, Cr, Mn, Fe, Co, Ni, Cu and Zn;
M″ is at least one element selected from the group consisting of the elements of groups 2, 3, 4, 5, 6, 7, 8, 9, 10, 11, 12, 13, 14, 15 and 16 of the periodic table of elements;
x and y, independently of one another, are numbers greater than 0;
z is a number greater than or equal to 0; and
a is a number greater than 0.

9. The rechargeable battery cell according to claim 1, wherein the positive electrode is rechargeable in the rechargeable battery cell at least up to an upper potential of 3.6 volts, at least up to an upper potential of 3.8 volts, at least up to an upper potential of 4.0 volts, at least to an upper potential of 4.2 volts and at least to an upper potential of 4.4 volts.

10. The rechargeable battery cell according to claim 1, wherein the substituents R¹, R², R³ and R⁴ of the first conductive salt have, independently of one another, the structure of the chemical group —OR⁵, wherein R⁵ is selected from the group consisting of C₁-C₁₀ alkyl, C₂-C₁₀ alkenyl, C₂-C₁₀ alkynyl, C₃-C₁₀ cycloalkyl, C₆-C₁₄ aryl and C₅-C₁₄ heteroaryl, wherein the aliphatic, cyclic, aromatic and heteroaromatic groups can be unsubstituted or substituted.

11. The rechargeable battery cell according to claim 1, wherein the substituent R⁵ is selected from the group consisting of:
C₁-C₆ alkyl;
C₂-C₆ alkenyl;
C₂-C₆ alkynyl;
C₃-C₆ cycloalkyl;
phenyl; and
C₅-C₇ heteroaryl;
wherein the aliphatic, cyclic, aromatic and heteroaromatic groups may be unsubstituted or substituted.

12. The rechargeable battery cell according to claim 11, wherein the substituent R⁵ is C₂-C₄ alkyl.

13. The rechargeable battery cell according to claim 11, wherein the substituent R⁵ is selected from the group consisting of 2-propyl, methyl and ethyl.

14. The rechargeable battery cell according to claim 11, wherein the substituent R⁵ is C₂-C₄ alkenyl.

15. The rechargeable battery cell according to claim 11, wherein the substituent R⁵ is ethenyl or propenyl.

16. The rechargeable battery cell according to claim 11, wherein the substituent R$ is C₂-C₄ alkynyl.

17. The rechargeable battery cell according to claim 1, wherein the aliphatic, cyclic, aromatic and heteroaromatic groups of the substituent R⁵ can be further substituted with
one or more halogen atoms, or
a chemical group selected from the group consisting of C₁-C₄ alkyl, C₂-C₄ alkenyl, C₂-C₄ alkynyl, phenyl, benzyl, and fully or partially halogenated, in particular fully or partially fluorinated C₁-C₄ alkyl, C₂-C₄ alkenyl, C₂-C₄ alkynyl, phenyl and benzyl.

18. The rechargeable battery cell according to claim 17, wherein the aliphatic, cyclic, aromatic and heteroaromatic groups of the substituent R⁵ can be further substituted with fluorine.

19. The rechargeable battery cell according to claim 1, wherein the substituent R⁵ is substituted by at least one CF₃ group or one OSO₂CF₃ group.

20. The rechargeable battery cell according to claim 1, wherein the chelate ligand is bidentate, in particular according to the formula —O—R⁵—O, or multidentate.

21. The rechargeable battery cell according to claim 1, wherein the first conductive salt is selected from the group consisting of:

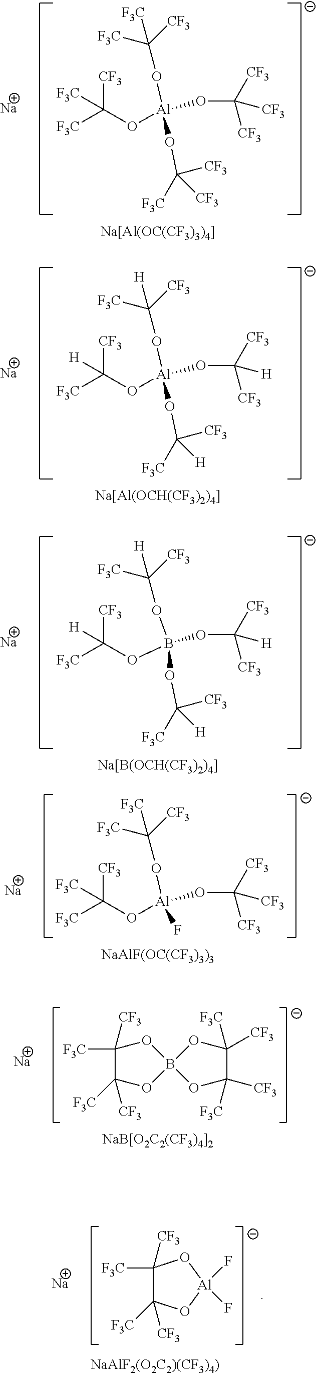

22. The rechargeable battery cell according to claim 1, wherein the electrolyte comprises:
5 to 99.4 wt. % sulfur dioxide,
0.6 to 95 wt. % of the first conductive salt,
0 to 25 wt. % of the second conductive salt and
0 to 10 wt. % of the additive,
relative to the total weight of the electrolyte composition.

23. The rechargeable battery cell according to claim 1, wherein the molar concentration of the first conductive salt is selected from the group of ranges consisting of: of 0.01 mol/L to 10 mol/L, preferably 0.05 mol/L to 10 mol/L, more preferably 0.1 mol/L to 6 mol/L, and particularly preferably 0.2 mol/L to 3.5 mol/L based on the total volume of the electrolyte.

24. The rechargeable battery cell according to claim 1, wherein the electrolyte includes a number of moles of SO₂ per mole of conductive salt selected from the group consisting of: at least 0.1 mole of SO₂; at least 1 mole of SO₂; at least 5 moles of SO₂; at least 10 moles of SO₂; and at least 20 moles of SO₂.

25. The rechargeable battery cell according to claim 1, wherein the electrolyte includes an organic solvent and the total organic solvent in the electrolyte is in the range selected from the group consisting of: 50 wt. %; 40 wt. %; 30 wt. %; 20 wt. %; 15 wt. %; 10 wt. %; 5 wt. %; 1 wt. % and substantially 0 wt. %.

26. The rechargeable battery cell according to claim 1, wherein the conducting element of the negative electrode is made of nickel, copper or aluminum.
